(19) United States
(12) Patent Application Publication
(10) Pub. No.: US 2026/0358893 A1
(43) Pub. Date: Nov. 12, 2026

(54) WEARABLE HAPTIC DEVICE FOR AUGMENTED REALITY

(71) Applicant: Vanderbilt University, Nashville, TN (US)

(72) Inventors: Tiange Zhang, Nashville, TN (US); Alexandra Cadence Watkins, Nashville, TN (US); Nilanjan Sarkar, Brentwood, TN (US); Yicheng Wang, Nashville, TN (US)

(21) Appl. No.: 19/672,093

(22) Filed: May 8, 2026

Related U.S. Application Data
(60) Provisional application No. 63/803,092, filed on May 9, 2025.

(51) Int. Cl. G06F 3/01; G02B 27/01

(52) U.S. Cl. CPC G06F 3/016; G02B 27/017; G06F 3/014; G06F 3/017

(57) ABSTRACT

Wearable devices, methods, and systems for providing haptic feedback in an augmented reality environment. One example wearable device includes a wrist brace configured to be worn on a forearm and a hand of a user. The wrist brace includes a force application interface positioned on a dorsal surface of the hand. The wrist brace is configured to leave fingers and a palm region of the hand substantially unobstructed. The wearable device includes an actuator coupled to the wrist brace and configured to apply a force to the force application interface. The actuator is coupled to a controller configured to receive input from a head-mounted display indicating an interaction between the hand and a virtual object and, in response to the input, cause the actuator to apply the force to the force application interface.

### RELATED APPLICATIONS

This application claims the benefit of U.S. Provisional Application No. 63/803,092, filed May 9, 2025, entitled “Wrist Exoskeleton for Weight Perception in Augmented Reality,” the entire contents of which is hereby incorporated by reference.

### STATEMENT REGARDING FEDERALLY SPONSORED RESEARCH OR DEVELOPMENT

This invention was made with government support under 2225890 awarded by the National Science Foundation, and AG078480 awarded by the National Institutes of Health. The government has certain rights in the invention.

### BACKGROUND

Augmented reality systems overlay virtual objects onto a real environment using head-mounted displays. Head-mounted displays render virtual content and track the position and movement of a user's hands to enable interaction with virtual objects. Users of augmented reality systems interact with both virtual and real objects in the same environment. Haptic feedback devices provide physical sensations to users interacting with virtual objects. Wearable haptic devices deliver force feedback to simulate physical properties of virtual objects, such as weight. Wearability is a consideration for haptic devices in augmented reality applications because users move freely within a workspace while interacting with both virtual and real objects.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system for providing haptic feedback in an augmented reality environment in accordance with some examples.

FIG. 2 is an illustration of a user wearing the system of FIG. 1 in accordance with some examples.

FIG. 3 is a hardware block diagram of the system of FIG. 1 in accordance with some examples.

FIG. 4 is a finite state machine diagram implemented by the system of FIG. 1 in accordance with some examples.

FIG. 5 is a closed-loop force control block diagram in accordance with some examples.

FIG. 6 is a perspective view of a wrist brace of a wearable haptic device in accordance with some examples.

FIG. 7 is a top view of the wrist brace of FIG. 6 in accordance with some examples.

FIG. 8 is a bottom view of the wrist brace of FIG. 6 in accordance with some examples.

FIG. 9 is a partially exploded front perspective view of a force application interface in accordance with some examples.

FIG. 10 is a partially exploded rear perspective view of the force application interface of FIG. 9 in accordance with some examples.

FIG. 11 is a perspective view of an actuator in accordance with some examples.

FIG. 12 is a perspective view of the actuator of FIG. 11 from an opposite side in accordance with some examples.

FIG. 13 is an end view of the actuator of FIG. 11 in accordance with some examples.

FIG. 14 is an exploded view of the actuator of FIG. 11 in accordance with some examples.

FIG. 15 is a perspective view of a controller housing enclosing an electronic controller in accordance with some examples.

FIG. 16 is an exploded view of the controller housing of FIG. 15 in accordance with some examples.

FIG. 17 is a flowchart of a method of providing haptic feedback to a user in an augmented reality environment in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Grounded haptic devices anchored to stable structures deliver reliable and accurate force feedback because the stable structure absorbs reaction forces without transmitting them to the user. However, grounded devices restrict user mobility and prevent users from freely navigating augmented reality environments. Augmented reality applications require users to move within a workspace, reach for objects at different locations, and orient their hands in various postures. A grounded device tethers the user to a fixed location, limiting the workspace to the reach envelope of the device. Wearable haptic devices address the mobility limitation by mounting on the user's body, but introduce design complexities because wearable devices use the human body as a ground to support reaction forces. The reaction forces generated during actuation are transmitted to the user's limb, which may cause discomfort, fatigue, or unintended movement of the limb during extended use.

Haptic devices designed for virtual reality applications often rely on fingertip attachments that induce skin deformation using vibrotactile feedback or mount actuating platforms on the fingertips. These solutions obstruct interactions with real objects because the mechanisms positioned on the fingertips prevent the user from grasping, pinching, or manipulating physical objects with the same hand. In augmented reality environments, users interact with both virtual and real objects in the same workspace, and the ability to transition between manipulating a virtual object and picking up a physical object without removing or reconfiguring the device is a practical requirement. Devices that occupy the fingers or palm impede this ability and reduce the utility of the augmented reality experience. Fingertip and hand-mounted haptic devices may also interfere with hand-tracking functionality of head-mounted displays. Head-mounted displays track the position and movement of a user's hands using cameras and depth sensors to enable interaction with virtual objects. Devices positioned on the fingers or palm may occlude portions of the hand from the tracking system, degrading tracking performance and causing missed or inaccurate gesture recognition.

Placing actuation units in close proximity to the fingers or forearms increases user fatigue. Kinesthetic devices that provide joint actuation tend to have bulkier form factors due to pneumatic systems, cable transmissions, linkage mechanisms, DC motors, and associated electronics. The mass of these components, when positioned on the hand or forearm, contributes to user fatigue during extended use because the user must support the weight of the device in addition to performing the intended task. Exoskeletons developed for rehabilitation purposes apply forces to the hand and wrist but have not been thoroughly explored for integration with augmented reality setups. Rehabilitation exoskeletons are designed to guide or resist joint movement for therapeutic purposes and may not account for the constraints imposed by augmented reality, such as maintaining line-of-sight for hand tracking, preserving finger dexterity for object manipulation, and minimizing visual obstruction of the hand region.

Pseudo-haptic approaches use visual cues to create haptic illusions without physical force feedback. For example, a pseudo-haptic system may slow the movement of a virtual object relative to the movement of the user's hand to create the illusion that the virtual object is heavy, or may visually deform a virtual object to suggest compliance or stiffness. While pseudo-haptics avoids the hardware complexity of actuated devices, this approach relies on a discrepancy between visual and motor signals that the user's nervous system may interpret as a haptic sensation. The illusion is limited to scenarios where the user's visual attention is directed at the virtual object and where the visual manipulation is subtle enough to avoid conscious detection. In augmented reality environments, the user simultaneously perceives real objects that obey physical laws and virtual objects that do not produce physical sensations. When a user lifts a real coffee mug and then reaches for a virtual coffee mug, the absence of gravitational force on the hand during the virtual interaction creates a perceptual mismatch that visual manipulation alone cannot resolve. The user's sensorimotor system has an internal model of gravity that informs expectations about grip force, load force, and arm posture when interacting with objects. Pseudo-haptic techniques do not engage this internal model because no physical force is applied to the body. As a result, the user is forced to switch between experiencing the physical weight of a real object and relying on visual cues for virtual objects, undermining immersion and realism in the augmented reality experience.

Thus, there exists a need for an improved technical method, device, and system for providing haptic feedback to simulate weight perception in augmented reality environments.

In accordance with one example embodiment, a wearable device for providing haptic feedback in an augmented reality environment is provided. The wearable device comprises a wrist brace configured to be worn on a forearm and a hand of a user. The wrist brace comprises a force application interface positioned on a dorsal surface of the hand. The wrist brace is configured to leave fingers and a palm region of the hand substantially unobstructed. The wearable device further comprises an actuator coupled to the wrist brace and configured to apply a force to the force application interface. The actuator is coupled to a controller configured to receive input from a head-mounted display indicating an interaction between the hand and a virtual object and, in response to the input, cause the actuator to apply the force to the force application interface.

In accordance with another example embodiment, the force may be directed to cause extension or flexion of a wrist joint of the user. The actuator may comprise a motor. The actuator may comprise a hydraulic actuator. The actuator may comprise a pneumatic actuator. The actuator may be located remotely from the wrist brace on the user's body, and a flexible transmission may couple the actuator to the wrist brace to transmit the force to the force application interface. The flexible transmission may comprise a Bowden cable and a Bowden cable sheath. The actuator may be mounted on a hip belt worn by the user. The wrist brace may further comprise an actuated joint configured to permit movement of the force application interface in wrist flexion and extension directions. The wrist brace may further comprise a passive joint configured to permit movement of the force application interface in wrist adduction and abduction directions. The wrist brace may comprise an adjustable clamp mechanism configured to accommodate different hand and wrist sizes. The wrist brace may further comprise at least one force sensor positioned in series with the actuator to measure force applied to the force application interface.

In accordance with another example embodiment, a method of providing haptic feedback to a user in an augmented reality environment is provided. The method comprises detecting, via a head-mounted display, an interaction between a hand of the user and a virtual object in the augmented reality environment. The method further comprises, in response to detecting the interaction, applying a force, via an actuator, to a force application interface positioned on a dorsal surface of the hand. The force application interface is configured to leave the fingers and a palm region of the user's hand substantially unobstructed. The method further comprises, when the interaction with the virtual object ceases, reducing the force applied by the actuator to substantially zero to permit unimpeded interaction with physical objects.

In accordance with another example embodiment, the force application interface may be part of a wrist brace. The force may be transmitted from the actuator to the force application interface via a flexible transmission, and the actuator may be located remotely from the force application interface on the user's body. Detecting the interaction may comprise detecting a predefined gesture between a thumb and an index finger of the user colliding with the virtual object. The force may correspond to a weight assigned to the virtual object. The method may further comprise applying force compensation based on a grip method used by the user to interact with the virtual object. The method may further comprise varying the force over time to simulate at least one of inertia, buoyancy, stiffness, or damping of the virtual object.

In accordance with another example embodiment, a system is provided. The system comprises a head-mounted display configured to render virtual objects in an augmented reality environment and to track a hand of a user. The system further comprises a wearable haptic device comprising a wrist brace configured to be worn on a forearm and the hand of the user. The wrist brace comprises a force application interface positioned on a dorsal surface of the hand. The wrist brace is configured to leave fingers and a palm region of the hand substantially unobstructed to preserve tracking of the hand by the head-mounted display. The system further comprises an actuator coupled to the wrist brace and configured to apply a force to the force application interface. The system further comprises a processor executing code to receive hand tracking data from the head-mounted display, determine when the hand of the user interacts with a virtual object, and command the actuator to apply the force to the force application interface to simulate a physical property of the virtual object.

In accordance with another example embodiment, the processor may execute code to operate in a transparent mode in which force applied to the hand by the actuator is minimized to permit interaction with physical objects, and a grasp mode in which the actuator applies a force corresponding to a physical property of the virtual object. The wearable haptic device may be configured to be used in combination with at least one additional feedback device worn on the hand of the user.

Each of the above-mentioned embodiments will be discussed in more detail below, starting with example system and device architectures of the system in which the embodiments may be practiced, followed by an illustration of processing blocks for achieving an improved technical method, device, and system for providing haptic feedback to simulate weight perception in augmented reality environments.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

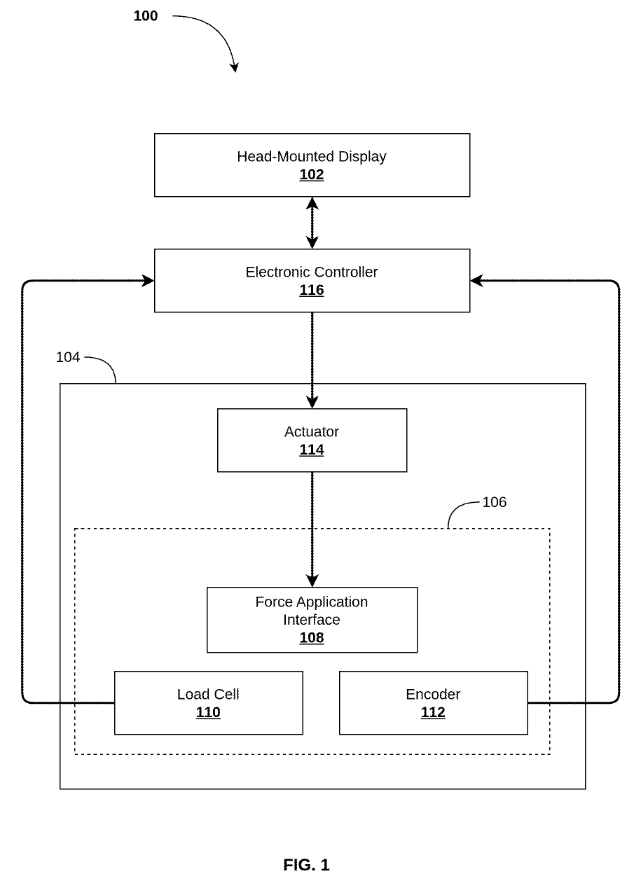

FIG. 1 is a block diagram of an example system 100 for providing haptic feedback in an augmented reality environment. As used herein, an “augmented reality environment” refers to a blended environment combining physical and virtual elements, in which virtual objects, such as holograms, are superimposed into the wearer’s or user’s physical surroundings or workspace.

In the example illustrated, the system 100 includes a head-mounted display 102, an electronic controller 116, and a wearable haptic device 104. The head-mounted display 102 is configured to render virtual objects in the augmented reality environment and to track a hand of a user. The head-mounted display 102 is in bidirectional communication with the electronic controller 116. The electronic controller 116 commands the wearable haptic device 104 based on input received from the head-mounted display 102.

The wearable haptic device 104 includes a wrist brace 106 and an actuator 114. The wrist brace 106 is configured to be worn on a forearm and the hand of the user. The wrist brace 106 includes a force application interface 108 positioned on a dorsal surface of the hand. The wrist brace 106 is configured to leave fingers and a palm region of the hand substantially unobstructed to preserve tracking of the hand by the head-mounted display 102. The actuator 114 is coupled to the wrist brace 106 and is configured to apply a force to the force application interface 108.

The wrist brace 106 further includes a load cell 110 and an encoder 112. The load cell 110 is positioned in series with the actuator 114 to measure force applied to the force application interface 108. The encoder 112 measures rotational position of the wrist brace 106. The load cell 110 and the encoder 112 provide feedback signals to the electronic controller 116 for closed-loop control of the force applied to the force application interface 108.

The electronic controller 116 is configured to receive input from the head-mounted display 102 indicating an interaction between the hand and a virtual object. In response to the input, the electronic controller 116 causes the actuator 114 to apply the force to the force application interface 108. The force applied to the force application interface 108 simulates a physical property of the virtual object, such as weight. When the interaction with the virtual object ceases, the electronic controller 116 reduces the force applied by the actuator 114 to permit unimpeded interaction with physical objects.

In some cases, the system 100 is compatible with the Microsoft HoloLens 2 head-mounted display, the Apple Vision Pro, the Meta Quest 3, or other commercial products suitable for hand tracking and augmented reality rendering.

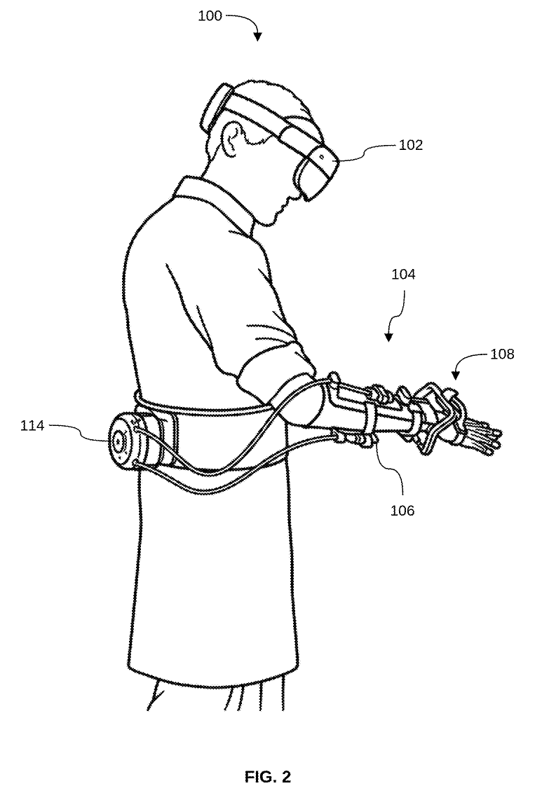

FIG. 2 illustrates but one example of the system 100 worn by a user in an augmented reality environment. In the example illustrated, a head-mounted display 102 is worn on the head of the user. A wearable haptic device 104 is worn on the forearm and hand of the user. The wearable haptic device 104 includes a wrist brace 106 secured to the forearm and a force application interface 108 positioned on a dorsal surface of the hand. The wrist brace 106 is configured to leave fingers and a palm region of the hand substantially unobstructed. The force application interface 108 is configured to minimize interference with hand tracking by the head-mounted display 102 while applying evenly distributed force to either the dorsal or ventral surface of the hand. Forces can be applied to either the dorsal surface or to the ventral (palmar) surface of the hand depending on the direction of force application by the actuator. Force transmission to the ventral surface may be achieved by an adjustable strap positioned around the user’s hand.

In the example illustrated in FIG. 2, an actuator 114 is located remotely from the wrist brace 106 on the user's body. The actuator 114 is mounted on a hip belt worn by the user. The hip belt may be cushioned to minimize user fatigue and distribute weight of the actuator 114 away from the hand. A flexible transmission couples the actuator 114 to the wrist brace 106 to transmit force to the force application interface 108. The flexible transmission is routed along the arm of the user from the hip belt to the wrist brace 106. By positioning the actuator 114 remotely on the hip belt, the mass of the actuator 114 is distributed away from the hand and forearm of the user. The remote positioning of the actuator 114 reduces the weight carried by the hand and forearm during use of the wearable haptic device 104.

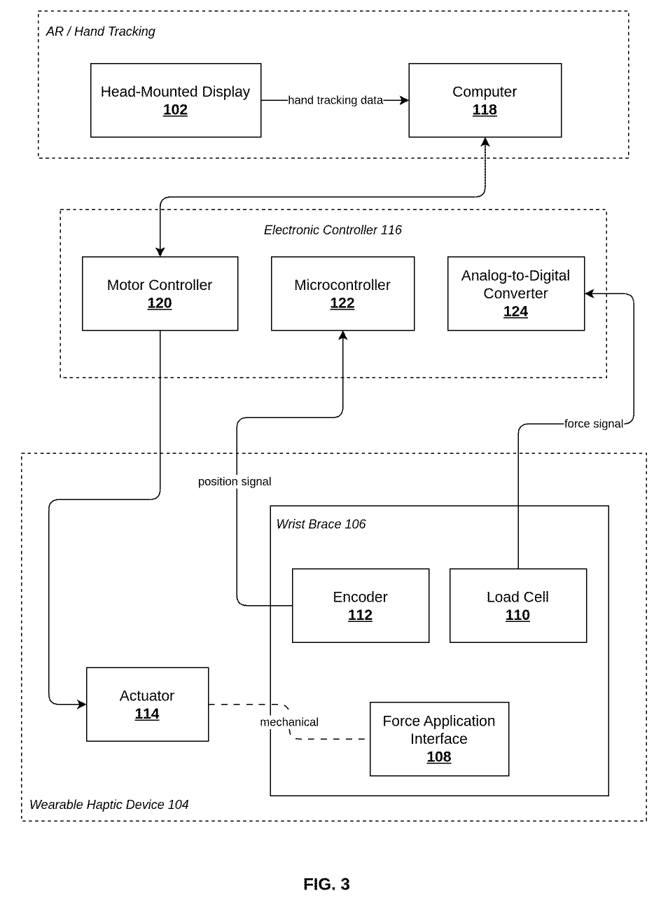

FIG. 3 illustrates but one example of a hardware block diagram of the system 100, organized into three subsystems. In the example illustrated, the system 100 includes an augmented reality and hand tracking subsystem, a motor control subsystem, and a wearable haptic device subsystem. The three subsystems are communicatively coupled to one another to enable closed-loop control of the force applied to the force application interface 108.

The augmented reality and hand tracking subsystem includes the head-mounted display 102 coupled to a computer 118. The head-mounted display 102 transmits hand tracking data to the computer 118. The computer 118 includes a processor executing code to receive hand tracking data from the head-mounted display 102, determine when the hand of the user interacts with a virtual object, and command the actuator 114 to apply the force to the force application interface 108 to simulate a physical property of the virtual object. In some cases, virtual objects and interaction detection are developed using the Unity game engine with the Microsoft Mixed Reality Toolkit. The computer 118 communicates bidirectionally with the motor control subsystem to transmit commands based on the hand tracking data received from the head-mounted display 102.

In some cases, the computer 118 executes a haptic rendering pipeline for weight perception. The haptic rendering pipeline includes generating a hand collision box based on hand tracking data received from the head-mounted display 102, detecting contact between the hand collision box and virtual objects in the augmented reality environment, and projecting the weight of the contacted virtual object onto the palm to generate a haptic waveform. The haptic waveform is transmitted to the electronic controller 116, which commands the actuator 114 to apply the corresponding force to the force application interface 108.

The motor control subsystem comprises the electronic controller 116. The electronic controller 116 includes a motor controller 120, a microcontroller 122, and an analog-to-digital converter 124. The motor controller 120 is configured to receive commands from the microcontroller 122 and drive the actuator 114. The microcontroller 122 is configured to process sensor data and communicate with the head-mounted display 102 via the computer 118. The analog-to-digital converter 124 is configured to amplify and digitize signals from the load cell 110. The motor controller 120 receives commands from the computer 118 and drives the actuator 114 based on the received commands. The microcontroller 122 receives position signals from the encoder 112 and force signals from the analog-to-digital converter 124 to enable closed-loop control of the force applied to the force application interface 108.

The wearable haptic device subsystem comprises the wearable haptic device 104. The wearable haptic device 104 includes the actuator 114, the wrist brace 106, the force application interface 108, the load cell 110, and the encoder 112. The actuator 114 is mechanically coupled to the force application interface 108 of the wrist brace 106. The load cell 110 sends a force signal to the analog-to-digital converter 124. The encoder 112 sends a position signal to the microcontroller 122. The force signal from the load cell 110 and the position signal from the encoder 112 provide feedback to the electronic controller 116 for closed-loop control of the force applied to the force application interface 108.

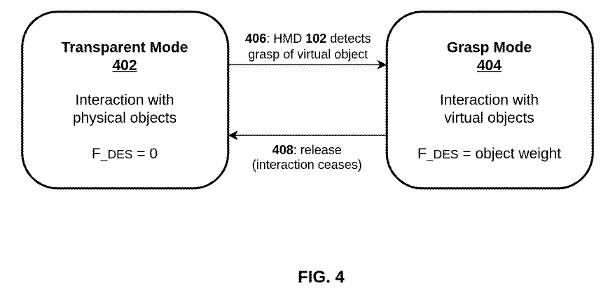

FIG. 4 illustrates but one example of a finite state machine implemented by the system 100. In the example illustrated, the system 100 operates in one of two control modes: a transparent mode 402 and a grasp mode 404. The finite state machine governs transitions between the transparent mode 402 and the grasp mode 404 based on input received from the head-mounted display 102. The head-mounted display 102 detects, via hand tracking, an interaction between the hand of the user and a virtual object in the augmented reality environment. In response to detecting the interaction, the electronic controller 116 causes the actuator 114 to apply a force to the force application interface 108 positioned on the dorsal surface of the hand and secured to the user’s hand, for example, with an adjustable strap. As described herein, the force application interface 108 is configured to leave the fingers and the palm region of the hand substantially unobstructed.

The transparent mode 402 corresponds to interaction with physical objects. In the transparent mode 402, a desired force applied to the force application interface 108 equals zero such that force applied to the hand of the user is minimized. The electronic controller 116 operates in the transparent mode 402 to permit unimpeded interaction with physical objects. In some cases, the electronic controller 116 implements a proportional-integral controller in the transparent mode 402 to minimize force applied to the force application interface 108 due to resistance from back-driving the actuator 114 and friction in the flexible transmission.

The grasp mode 404 corresponds to interaction with virtual objects. In the grasp mode 404, the desired force equals a weight assigned to the virtual object. The actuator 114 applies a force corresponding to a physical property of the virtual object, such as weight. In some cases, the electronic controller 116 implements a proportional-integral controller in the grasp mode 404 to command a force equivalent to the weight of the virtual object.

A grasp transition 406 occurs from the transparent mode 402 to the grasp mode 404 when the head-mounted display 102 detects a grasping interaction with the virtual object. The system 100 is configured to detect a predefined gesture to trigger the grasp transition 406. In some cases, the system 100 is configured to detect a pinching motion where a thumb and an index finger of the user collide with the virtual object to trigger the grasp mode 404. In some cases, the system 100 is configured to detect a power grip where all five fingers engage the virtual object to trigger the grasp mode 404. In some cases, the system 100 is configured to detect a holding grip where the virtual object is placed on the palm to trigger the grasp mode 404.

In some cases, the system 100 detects interactions between the hand of the user and virtual objects using one of two detection methods, though other detection methods are possible. In the first example detection method, the system 100 detects a gesture when the hand overlaps with a virtual object. In some instances, the gesture may be predefined. For example, a predefined gesture may comprise a pinching motion where a thumb and an index finger of the user collide with the virtual object, a power grip where all five fingers engage the virtual object, or a holding grip where the virtual object is placed on the palm of the user. In some instances, the system 100 detects gestures that are not predefined but are instead recognized dynamically using machine learning or other adaptive recognition methods. For example, the system 100 may train a gesture recognition model based on observed user behavior to detect grasping interactions that do not conform to a predefined gesture template. The first detection method is used for augmented reality applications where picking up and moving a virtual object is required, and the system 100 transitions to the grasp mode 404 to apply a force corresponding to the weight of the virtual object. In the second example detection method, the system 100 detects an overlap or collision between any portion of the hand of the user and a virtual object without requiring the detection of a specific gesture. In some cases, the second detection method detects that the hand of the user comes in contact with the virtual object. Contact may be detected when any portion of the hand, such as a fingertip, a knuckle, or the palm, overlaps with or enters the boundary of the virtual object. The second detection method may be used to represent, for example, virtual obstacles, walls, or other objects that the user does not pick up and move. For example, the system 100 may detect that the hand of the user has pressed against a virtual wall or bumped into a virtual object on a work surface, and in response apply a resistive force to the force application interface 108 that opposes further movement of the hand into the virtual object. The second detection method enables the system 100 to provide haptic feedback for contact interactions in addition to grasping interactions.

A release transition 408 occurs from the grasp mode 404 to the transparent mode 402 when the interaction with the virtual object ceases. When the release transition 408 occurs, the electronic controller 116 reduces the force applied by the actuator 114 to substantially zero to permit unimpeded interaction with physical objects.

The finite state machine operates at a high level to detect grasping and release events. In some cases, the high-level finite state machine operates at an update rate of 30-60 Hz, limited by the frame rate of the augmented reality application running on the head-mounted display 102. A low-level controller operates at a higher update rate to perform closed-loop force control. In some cases, the low-level controller operates at an average update rate greater than 300 Hz.

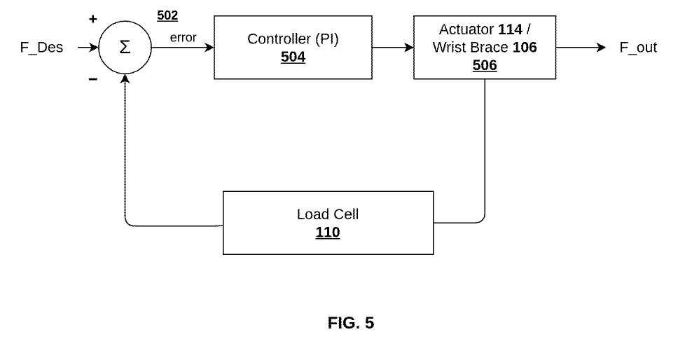

FIG. 5 illustrates but one example of a closed-loop force control block diagram implemented by the electronic controller 116. In the example illustrated, the electronic controller 116 implements a proportional-integral (PI) control scheme to minimize force error between commanded and applied forces. The closed-loop force control block diagram includes a summing junction 502, a controller 504, and a plant 506. The summing junction 502 receives a desired force input F_{Des} representing the force to be applied to the force application interface 108. The summing junction 502 also receives a feedback signal representing the actual applied force. The summing junction 502 outputs an error signal representing the difference between the desired force input and the actual applied force.

The controller 504 receives the error signal from the summing junction 502. The controller 504 comprises a PI controller configured to generate a command signal based on the error signal. The command signal is supplied to the plant 506. The plant 506 represents the actuator 114 and the wrist brace 106. The plant 506 produces an output force Fₒᵤₜ applied to the force application interface 108.

A feedback path returns the output force Fₒᵤₜ through the load cell 110. As described herein, the wrist brace 106 includes at least one force sensor positioned in series with the actuator 114 to measure force applied to the force application interface 108. In some cases, the wrist brace 106 includes a pair of load cells 110 positioned in series with a cable transmission path to measure tension in the system for both extension and flexion of the wrist. The load cell 110 measures the actual applied force and provides the feedback signal to the summing junction 502. The summing junction 502 subtracts the feedback signal from the desired force input F_{Des} to form the error signal. The closed-loop configuration minimizes the error between the desired force and the actual force applied to the force application interface 108.

In the transparent mode 402, the electronic controller 116 implements the PI controller to minimize the force difference between the two load cells 110. Minimizing the force difference between the two load cells 110 minimizes the resistive force applied at the force application interface 108. The transparent mode 402 reduces interaction forces when the wearable haptic device 104 is not applying force to simulate a virtual object.

In the grasp mode 404, the electronic controller 116 implements the PI controller with different gains to command a force representing the weight of the grasped virtual object. The PI controller compensates for open-loop efficiency loss in the flexible transmission, allowing the cable force to track and reach the desired force. In some cases, the flexible transmission comprises a Bowden cable system having a force transmission efficiency of approximately 73 percent.

In some cases, the electronic controller 116 implements a feed-forward current control law to generate force responses that mimic an object being gently dropped into the hand of the user. The step response of the force control system may exhibit an initial overshoot to replicate inertial interactions experienced during object settling on the hand. The control parameters may be tuned to achieve the desired simulation of inertial interactions.

In some cases, the total system latency from a software command to the application of perceivable force at the force application interface 108 is under 50 milliseconds. In some cases, the total system latency includes an average command transmission time from software to the wearable haptic device 104 of under 10 milliseconds, and a subsequent onset of applied force in under 30 milliseconds based on the system rise time. The cable tension may reach a steady state tension corresponding to the desired commanded force within 50 milliseconds. In some cases, under closed-loop control, the maximum force that can be applied to the hand is approximately 10.75 N. In some cases, the minimum force that can be applied to the hand is approximately 1.75 N.

In some cases, the system 100 has a position control bandwidth higher than 5 Hz at a force amplitude of 9.5 N. At lower frequencies, the actual position closely tracks the desired position with minimal deviation. At higher frequencies, some phase lag and amplitude attenuation may appear. Position tracking error may increase when the direction of motion changes due to cable slack in the Bowden cable system. The position control bandwidth is sufficient for wrist-related activities, as the biological wrist does not typically move faster than 5 Hz during continuous motions in daily activities.

In some cases, the just-noticeable-difference for force discrimination while using the wearable haptic device 104 is approximately 13-15 percent. The just-noticeable-difference represents the minimal detectable change in magnitude between a reference stimulus and a comparison stimulus that a user can reliably identify.

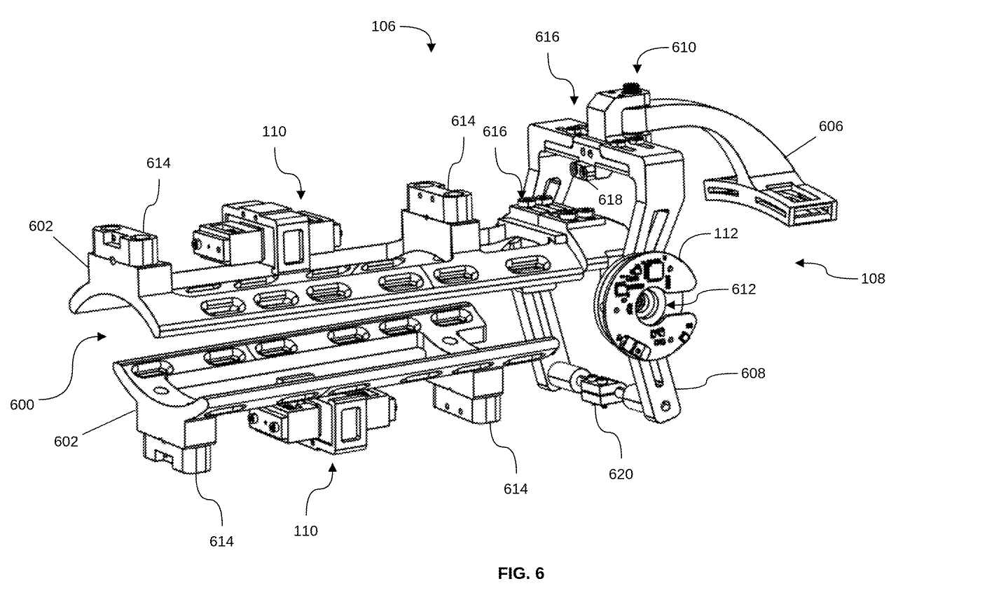

FIG. 6 illustrates but one example of a perspective view of the wrist brace 106 of the wearable haptic device 104. In the example illustrated, the wrist brace 106 includes a forearm brace 600, a palm holder 606, a structural frame 608, a passive joint 610, an actuated joint 612, an encoder 112, a plurality of bowden sheaths 614, an upper cable attachment 618, a lower cable attachment 620, an adjustable clamp 616, and a pair of load cells 110. The wrist brace 106 is configured to be worn on the forearm and the hand of the user. The force application interface 108 is part of the wrist brace 106 and is positioned on the dorsal surface of the hand.

The forearm brace 600 includes an upper portion 602 and a lower portion 604 that extend along the forearm of the user. The upper portion 602 is configured to engage a dorsal portion of the forearm. The lower portion 604 is configured to engage a ventral portion of the forearm. The upper portion 602 and the lower portion 604 clamp around the forearm of the user to secure the wrist brace 106 in position. The forearm brace 600 serves as a stabilizing anchor that counterbalances forces exerted by the bowden sheaths 614 during actuation. In some cases, the wrist brace 106 is fastened to the forearm using Velcro straps for quick tightening and releasing. In some cases, components of the wrist brace 106 are 3D printed from plastic material.

The palm holder 606 is configured to be secured to the dorsal surface of the hand of the user by a flexible strap. The palm holder 606 interfaces with the palm and back of the hand to distribute applied forces evenly. The palm holder 606 is configured to minimize interference with hand tracking by the head-mounted display 102 while applying evenly distributed force to the dorsal surface of the hand.

The structural frame 608 supports the palm holder 606 and is coupled between the palm holder 606 and the upper portion 602 of the forearm brace 600. The structural frame 608 connects the forearm brace 600 to the palm holder 606 and supports the passive joint 610 and the actuated joint 612.

The passive joint 610 couples the structural frame 608 to the palm holder 606. The passive joint 610 permits the user to move the wrist laterally to adduct and abduct the wrist. The passive joint 610 is configured to permit movement of the force application interface 108 in wrist adduction and abduction directions. The passive joint 610 counterbalances the shifting center of rotation of the wrist during various tasks.

In some cases, the passive joint 610 is replaced with a second actuated joint configured to apply force in the adduction and abduction directions. Actuating both joints enables force feedback when the user picks up a virtual object with various wrist orientations by distributing force application between both joints. For example, the system 100 may apply force in both the flexion/extension and adduction/abduction directions simultaneously to simulate the weight of a virtual object held at an angle, such as when holding a mug by its handle or laterally rotating a grasped object.

In some cases, the second actuated joint is driven by additional Bowden cables routed from the actuator 114 through additional bowden sheaths 614 along the forearm brace 600. The additional Bowden cables may be terminated at the structural frame 608 at positions offset from the axis of the second actuated joint to apply torque in the adduction and abduction directions. In some cases, the second actuated joint is driven by a motor mounted at or near the passive joint 610 on the wrist brace 106. Mounting the motor at or near the joint eliminates the need for additional Bowden cables for the second actuated joint.

The actuated joint 612 couples the structural frame 608 to the upper portion 602 of the forearm brace 600. The actuated joint 612 defines an axis about which the structural frame 608 rotates to flex and extend the wrist of the user. The actuated joint 612 is configured to permit movement of the force application interface 108 in wrist flexion and extension directions. The actuated joint 612 comprises a hinge mechanism driven by a Bowden cable to apply torque in extension and flexion directions. The force applied by the actuator 114 is directed to cause extension or flexion of a wrist joint of the user through the actuated joint 612.

The encoder 112 is positioned coaxially with the actuated joint 612 to measure rotational position of the actuated joint 612. The encoder 112 provides position feedback to the electronic controller 116 for closed-loop control of the force applied to the force application interface 108.

The plurality of bowden sheaths 614 are routed along the forearm brace 600 to convey actuation force from the actuator 114 to the force application interface 108. As described herein, the flexible transmission comprises a Bowden cable and a Bowden cable sheath. In some cases, the Bowden cable comprises stainless-steel braided wire rope with a diameter of approximately 0.79 cm. In some cases, the Bowden cable sheath comprises two concentric PTFE-coated tubes that guide the cable while counterbalancing forces during wrist actuation. The Bowden cable sheath guides the cable and provides counterbalancing force from the forearm brace 600 while the wrist is actuated.

The upper cable attachment 618 and the lower cable attachment 620 secure ends of cables routed within the bowden sheaths 614 to the structural frame 608. When the cables are pulled by the actuator 114, the structural frame 608 rotates about the axis of the actuated joint 612. Rotation of the structural frame 608 causes the palm holder 606 to flex or extend the wrist of the user. Wrist extension is achieved by applying tension on the cable attached at the upper cable attachment 618. Wrist flexion is achieved by applying tension on the cable attached at the lower cable attachment 620. Since the two cables remain taut, when one cable is actuated, the other cable passively follows.

The adjustable clamp 616 is provided on the forearm brace 600 to accommodate different hand and wrist sizes. The adjustable clamp 616 comprises an adjustable clamp mechanism configured to accommodate different hand and wrist sizes. In some cases, the adjustable clamp 616 changes the width of the wrist clamp to fit wrists ranging from 6 cm to 8.4 cm in width.

The pair of load cells 110 are positioned in series with a cable transmission path to measure force applied to the force application interface 108. The load cells 110 measure tension in the system for both extension and flexion of the wrist. In some cases, the load cells 110 are mounted on a 3D-printed holder that translates along horizontal cables to prevent rotation and reduce friction. The horizontal cables prevent the load cells 110 from rotating during translation.

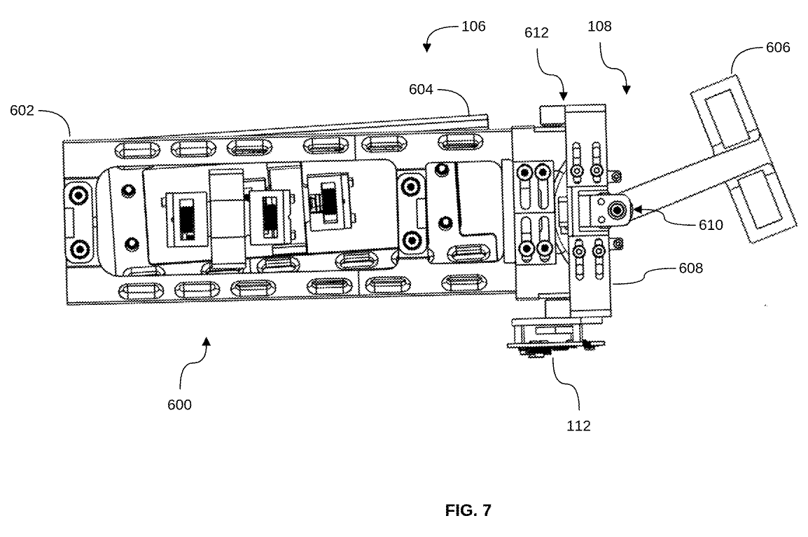

FIG. 7 illustrates but one example of a top view of the wrist brace 106. As described herein with reference to FIG. 6, the wrist brace 106 includes a forearm brace 600, a palm holder 606, a structural frame 608, a passive joint 610, an actuated joint 612, and an encoder 112. The top view illustrates the forearm brace 600 with upper portion 602 and lower portion 604 arranged in parallel and extending along the forearm of the user. The parallel arrangement of the upper portion 602 and the lower portion 604 provides a stabilizing structure that secures the wrist brace 106 to the forearm of the user. In some cases, the range of motion for the passive joint 610 is approximately 160 degrees for adduction and abduction. In some cases, the range of motion for the actuated joint 612 is approximately 70 degrees for extension and flexion.

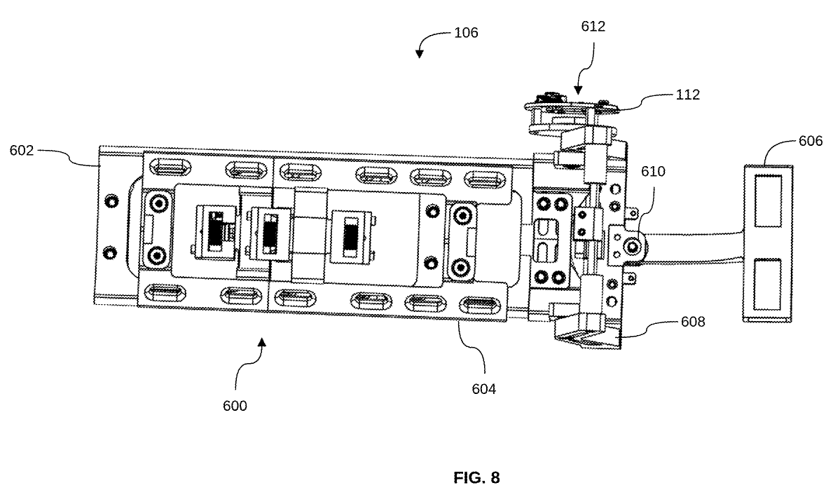

FIG. 8 illustrates but one example of a bottom view of the wrist brace 106 taken from a side opposite the view shown in FIG. 7. The bottom view provides a perspective of the wrist brace 106 from the ventral side of the forearm, revealing the arrangement of components as viewed from below the forearm of the user. The bottom view illustrates the lower portion 604 in the foreground, with the upper portion 602 visible beyond the lower portion 604. The wrist brace 106 includes the forearm brace 600, palm holder 606, structural frame 608, passive joint 610, actuated joint 612, and encoder 112 as described herein with reference to FIG. 6.

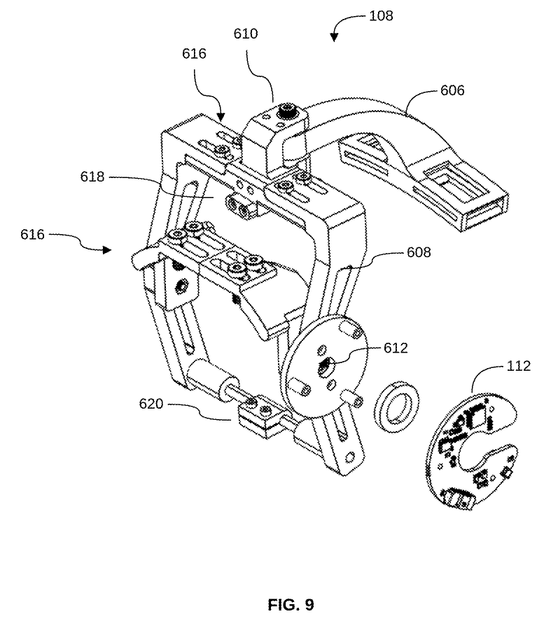

FIG. 9 illustrates but one example of a partially exploded front perspective view of the force application interface 108 of the wrist brace 106. In the example illustrated, the force application interface 108 includes a palm holder 606, a structural frame 608, a passive joint 610, an actuated joint 612, an upper cable attachment 618, a lower cable attachment 620, adjustable clamps 616, and an encoder 112. The partially exploded view illustrates the spatial relationships between components and the mounting interfaces that connect the components together.

The palm holder 606 is configured to be secured to the dorsal surface of the hand of the user by a flexible strap. The palm holder 606 interfaces with the palm and back of the hand to distribute applied forces evenly across the dorsal surface. The structural frame 608 supports the palm holder 606 and provides a mechanical linkage between the palm holder 606 and the forearm brace 600. The structural frame 608 connects the palm holder 606 to the upper portion 602 of the forearm brace 600 and supports the passive joint 610 and the actuated joint 612.

The passive joint 610 couples the structural frame 608 to the palm holder 606. The passive joint 610 permits the user to move the wrist laterally to adduct and abduct the wrist. The passive joint 610 comprises a pivot mechanism that allows free movement in adduction and abduction directions without active control from the actuator 114. The passive joint 610 counterbalances the shifting center of rotation of the wrist during various tasks.

The actuated joint 612 couples the structural frame 608 to the upper portion 602 of the forearm brace 600. The actuated joint 612 defines an axis about which the structural frame 608 rotates to flex and extend the wrist of the user. In the partially exploded view, the actuated joint 612 is shown exploded outward from the structural frame 608 to illustrate the mounting interface between the actuated joint 612 and the structural frame 608. The exploded arrangement reveals how the actuated joint 612 aligns with and attaches to the structural frame 608 during assembly.

The encoder 112 is shown exploded outward from the actuated joint 612 in coaxial alignment with the actuated joint 612. The coaxial positioning of the encoder 112 with the actuated joint 612 enables direct measurement of the angular position of the structural frame 608 relative to the forearm brace 600. The encoder 112 provides position feedback to the electronic controller 116 for closed-loop control of the force applied to the force application interface 108. The exploded view illustrates how the encoder 112 mounts to the actuated joint 612 along the axis of rotation.

The upper cable attachment 618 and the lower cable attachment 620 secure ends of cables routed within the bowden sheaths 614 to the structural frame 608. The upper cable attachment 618 is positioned on an upper side of the structural frame 608. The lower cable attachment 620 is positioned on a lower side of the structural frame 608. When the cables are pulled by the actuator 114, the structural frame 608 rotates about the axis of the actuated joint 612. Rotation of the structural frame 608 causes the palm holder 606 to flex or extend the wrist of the user.

The adjustable clamps 616 secure the structural frame 608 to the forearm brace 600. The adjustable clamps 616 accommodate different hand and wrist sizes by permitting adjustment of the position of the structural frame 608 relative to the forearm brace 600. The front perspective view reveals the arrangement of the adjustable clamps 616 relative to the structural frame 608 and the forearm brace 600.

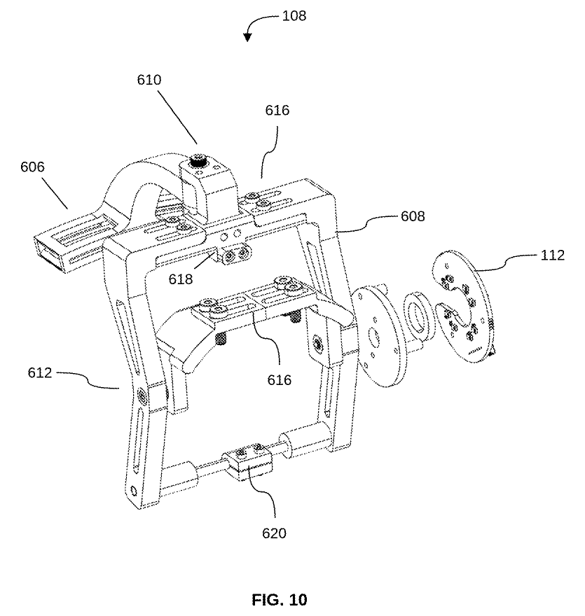

FIG. 10 illustrates but one example of a partially exploded rear perspective view of the force application interface 108 of the wrist brace 106, taken from a side opposite the view shown in FIG. 9. As described herein with reference to FIG. 9, the force application interface 108 includes a palm holder 606, a structural frame 608, a passive joint 610, an actuated joint 612, an upper cable attachment 618, a lower cable attachment 620, adjustable clamps 616, and an encoder 112. The rear perspective view reveals the arrangement of components from the opposite side of the force application interface 108, illustrating mounting interfaces and component relationships not visible in the front perspective view of FIG. 9. The rear perspective view reveals the attachment features and alignment surfaces of the actuated joint 612 that mate with corresponding features on the structural frame 608 during assembly. In some cases, the force application interface 108 is positioned on both the dorsal surface and a palmar surface of the hand to transmit contact forces in both extension and flexion directions.

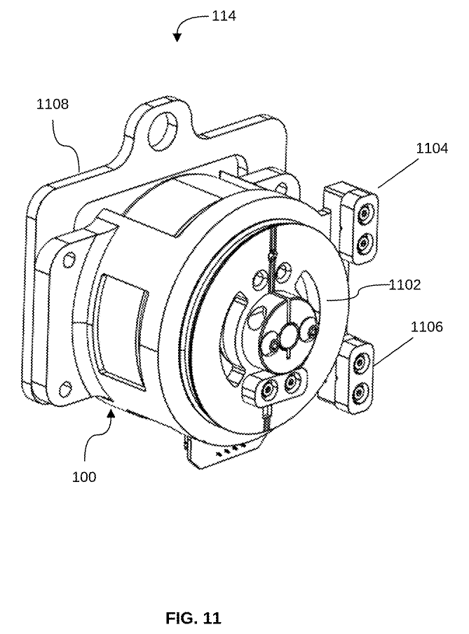

FIG. 11 illustrates but one example of a perspective view of the actuator 114 of the system 100. In the example illustrated, the actuator 114 is configured to be mounted remotely from the wrist brace 106 on the body of the user. As described herein, the actuator 114 is located remotely from the force application interface 108 on the body of the user, and a flexible transmission couples the actuator 114 to the wrist brace 106 to transmit force to the force application interface 108. The remote positioning of the actuator 114 distributes the mass of the actuator 114 away from the hand and forearm of the user.

The actuator 114 includes a motor 1100 that drives a pulley 1102. The motor 1100 comprises a brushless DC motor. In some cases, the motor 1100 includes a built-in encoder for position feedback. The pulley 1102 is coupled to the motor 1100 such that rotation of the motor 1100 causes the pulley 1102 to rotate. The pulley 1102 winds and unwinds cables routed within the bowden sheaths 614 to transmit force to the wrist brace 106. When the motor 1100 rotates in a first direction, the pulley 1102 applies tension to a cable that induces wrist extension. When the motor 1100 rotates in a second direction opposite the first direction, the pulley 1102 applies tension to a cable that induces wrist flexion.

An upper bowden cable sheath clamp 1104 and a lower bowden cable sheath clamp 1106 secure ends of the bowden sheaths 614 to the actuator 114. The upper bowden cable sheath clamp 1104 is positioned on an upper side of the actuator 114. The lower bowden cable sheath clamp 1106 is positioned on a lower side of the actuator 114. The upper bowden cable sheath clamp 1104 and the lower bowden cable sheath clamp 1106 anchor the bowden sheaths 614 such that cables routed within the bowden sheaths 614 extend to the pulley 1102. Rotation of the pulley 1102 by the motor 1100 pulls the cables to apply force to the force application interface 108 of the wrist brace 106.

An actuator mount 1108 extends from a housing of the actuator 114. The actuator mount 1108 is configured to secure the actuator 114 to a hip belt worn by the user. The hip belt positions the actuator 114 at the hip of the user, distributing the weight of the actuator 114 away from the hand and forearm. In some cases, the hip belt is cushioned to minimize user fatigue and distribute the weight of the actuator 114.

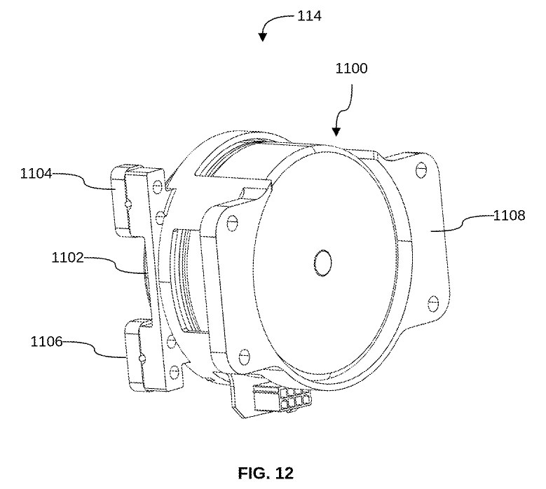

FIG. 12 illustrates but one example of a perspective view of the actuator 114 taken from a side opposite the view shown in FIG. 11. As described herein with reference to FIG. 11, the actuator 114 includes a motor 1100, a pulley 1102, an upper bowden cable sheath clamp 1104, a lower bowden cable sheath clamp 1106, and an actuator mount 1108. The perspective view from the opposite side reveals the arrangement of the upper bowden cable sheath clamp 1104 and the lower bowden cable sheath clamp 1106 relative to the pulley 1102 and the housing of the actuator 114.

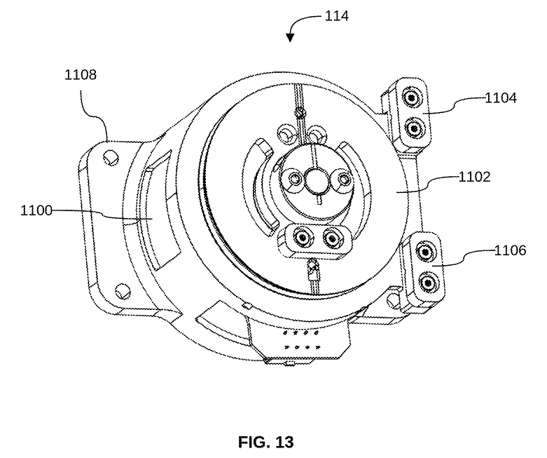

FIG. 13 illustrates but one example of an end view of the actuator 114 taken along an axis of rotation of the pulley 1102. The end view provides a perspective of the actuator 114 looking directly along the rotational axis of the pulley 1102. The end view illustrates the pulley 1102 centered within the housing of the actuator 114, with the motor 1100 positioned behind the pulley 1102 along the axis of rotation. The upper bowden cable sheath clamp 1104 and the lower bowden cable sheath clamp 1106 are arranged on opposite sides of the pulley 1102. The actuator mount 1108 extends from the housing of the actuator 114.

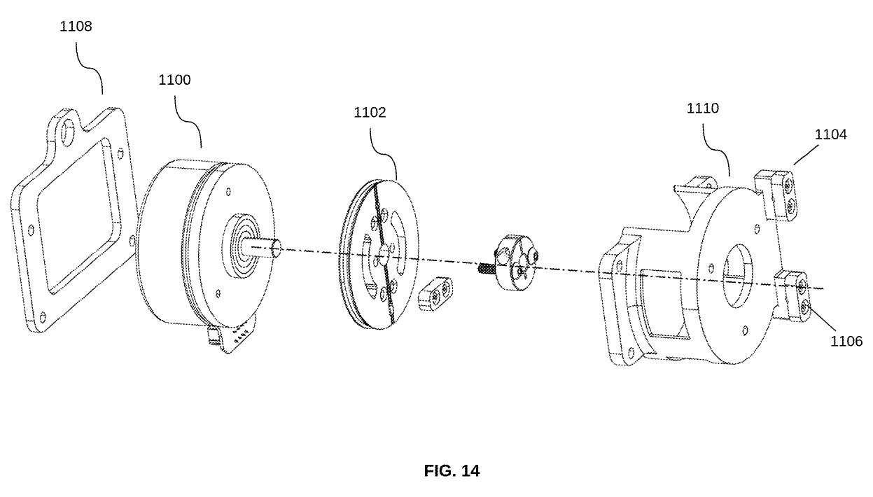

FIG. 14 illustrates but one example of an exploded view of the actuator 114 with components arranged along a central axis indicated by a dashed line. The exploded view reveals the individual components of the actuator 114 and the spatial relationships between the components during assembly. The components are arranged sequentially along the central axis to illustrate how the components align and assemble to form the actuator 114. The actuator mount 1108 is positioned at one end of the central axis. The motor 1100 is positioned adjacent to the actuator mount 1108 along the central axis and includes a drive shaft extending along the central axis. The pulley 1102 is configured to be coupled to the drive shaft of the motor 1100 such that rotation of the motor 1100 rotates the pulley 1102 about the central axis. In some cases, the pulley 1102 is 3D printed and is designed to have a radius matching the distance from the wrist joint to the cable termination points at the palm holder 606 to minimize backlash or slack in the cables. An actuator housing 1110 receives the pulley 1102 and supports the upper bowden cable sheath clamp 1104 and the lower bowden cable sheath clamp 1106 on opposite sides of the central axis.

In some cases, the actuator 114 comprises a hydraulic actuator. In some cases, the actuator 114 comprises a pneumatic actuator. Hydraulic and pneumatic actuators may be used as alternatives to the motor 1100 to provide actuation force to the wrist brace 106. However, pneumatic and hydraulic systems may necessitate an external pressure source that produces noise, which may detract from the intended immersive experience in the augmented reality environment. The Bowden cable system described herein avoids this noise penalty while enabling the actuation unit to be located at a distance from the wrist brace without additional design complexity or weight penalties.

In some cases, the actuator 114 and the electronic controller 116 are mounted directly on the wrist brace 106 instead of being located remotely on the hip belt. Mounting the actuator 114 and the electronic controller 116 on the wrist brace 106 eliminates the flexible transmission and the hip belt, resulting in a self-contained wearable haptic device 104. The self-contained configuration may increase the mass carried by the forearm of the user but may improve ease of donning and doffing and reduce the routing of cables along the body of the user. In some cases, a smaller motor is used in the self-contained configuration to reduce the mass of the wrist brace 106.

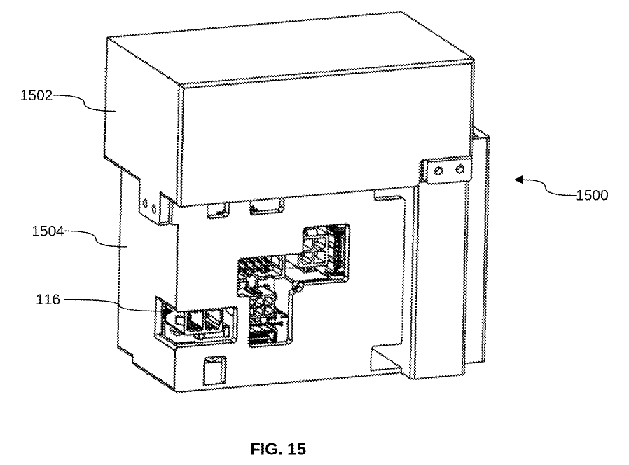

FIG. 15 illustrates but one example of a perspective view of a controller housing 1500 enclosing the electronic controller 116. In the example illustrated, the controller housing 1500 is configured to protect and support the electronic controller 116. As described herein, the electronic controller 116 includes the motor controller 120, the microcontroller 122, and the analog-to-digital converter 124. The controller housing 1500 encloses the motor controller 120, the microcontroller 122, and the analog-to-digital converter 124 within a protective enclosure.

The controller housing 1500 includes an upper housing 1502 and a lower housing 1504. The upper housing 1502 and the lower housing 1504 mate together to enclose the electronic controller 116. The upper housing 1502 is configured to engage the lower housing 1504 along mating surfaces to define an interior cavity that receives the electronic controller 116. The mating configuration of the upper housing 1502 and the lower housing 1504 provides a protective enclosure for the electronic controller 116 during operation of the system 100.

The lower housing 1504 includes openings exposing electrical connectors of the electronic controller 116. The openings in the lower housing 1504 are configured to receive cabling for power and communication with the motor 1100, the encoder 112, and the load cells 110. The electrical connectors provide interfaces for transmitting power to the electronic controller 116 and for communicating control signals and sensor data between the electronic controller 116 and the components of the wearable haptic device 104.

In some cases, the system 100 is powered by a benchtop power supply for initial prototyping. In some cases, the system 100 is powered by a battery mounted on the hip belt to improve portability for wearable operation. Battery power provides an alternative to the benchtop power supply for portable operation of the system 100.

In some cases, the system 100 implements open-loop control instead of closed-loop control. Open-loop control may simplify the system 100 by removing the load cells 110 and reducing the form factor of the wrist brace 106. Open-loop control may be used in applications where enhancing realism and immersiveness of the augmented reality experience is prioritized over precision force feedback.

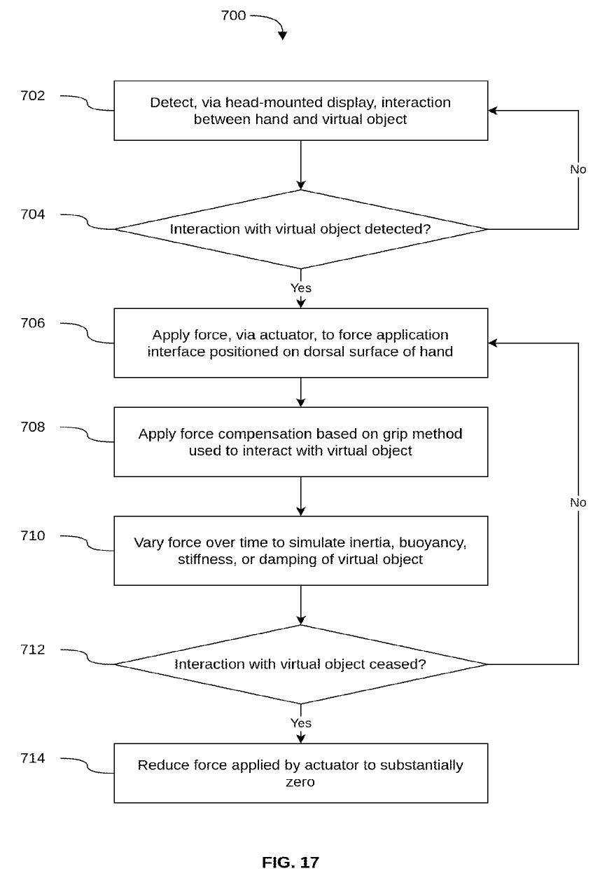

FIG. 17 illustrates but one example of a flowchart of a method 700 of providing haptic feedback to a user in an augmented reality environment. In the example illustrated, the method 700 is performed by the system 100 described herein with reference to FIGS. 1-5. At step 702, the head-mounted display 102 detects an interaction between a hand of the user and a virtual object in the augmented reality environment. The head-mounted display 102 tracks the position and movement of the hand of the user using hand tracking and determines when the hand contacts or grasps the virtual object. In some cases, detecting the interaction comprises detecting a predefined gesture, such as a pinching motion where a thumb and an index finger of the user collide with the virtual object, a power grip where all five fingers engage the virtual object, or a holding grip where the virtual object is placed on the palm of the user. At step 704, the method 700 determines whether an interaction with the virtual object is detected. If no interaction is detected, the method 700 returns to step 702 and continues monitoring for an interaction. The system 100 remains in the transparent mode 402 described herein with reference to FIG. 4, in which the force applied to the hand of the user is minimized to permit unimpeded interaction with physical objects.

If an interaction is detected at step 704, the method 700 proceeds to step 706, where the actuator 114 applies a force to the force application interface 108 positioned on the dorsal surface of the hand. The force application interface 108 is configured to leave the fingers and the palm region of the hand substantially unobstructed, as described herein with reference to FIGS. 6-10. The force corresponds to a weight assigned to the virtual object. The system 100 transitions from the transparent mode 402 to the grasp mode 404 described herein with reference to FIG. 4, and the electronic controller 116 commands the actuator 114 to apply the force using the closed-loop force control described herein with reference to FIG. 5. At step 708, force compensation is applied based on a grip method used by the user to interact with the virtual object. As described herein, the electronic controller 116 increases the force associated with the virtual object by a percentage based on the grip method used, such as a pinch grip, a power grip, or a holding grip. The force compensation accounts for the absence of kinesthetic feedback from the fingers when interacting with virtual objects. At step 710, the force is varied over time to simulate at least one of inertia, buoyancy, stiffness, or damping of the virtual object. As described herein, the electronic controller 116 may implement impedance control to vary the force based on the position, velocity, or acceleration of the hand of the user to simulate physical properties of the virtual object during manipulation.

At step 712, the method 700 determines whether the interaction with the virtual object has ceased. The head-mounted display 102 monitors the hand of the user to detect a release event, such as when the user opens the hand or moves the hand away from the virtual object. If the interaction has not ceased, the method 700 returns to step 706 and continues applying the force to the force application interface 108. The method 700 continues to loop through steps 706, 708, 710, and 712 while the user maintains the interaction with the virtual object, continuously applying force compensation and varying the force over time to simulate physical properties of the virtual object. If the interaction has ceased at step 712, the method 700 proceeds to step 714, where the force applied by the actuator 114 is reduced to substantially zero to permit unimpeded interaction with physical objects. The system 100 transitions from the grasp mode 404 to the transparent mode 402, and the electronic controller 116 minimizes the force applied to the force application interface 108. The method 700 then returns to step 702 to monitor for a subsequent interaction between the hand of the user and a virtual object.

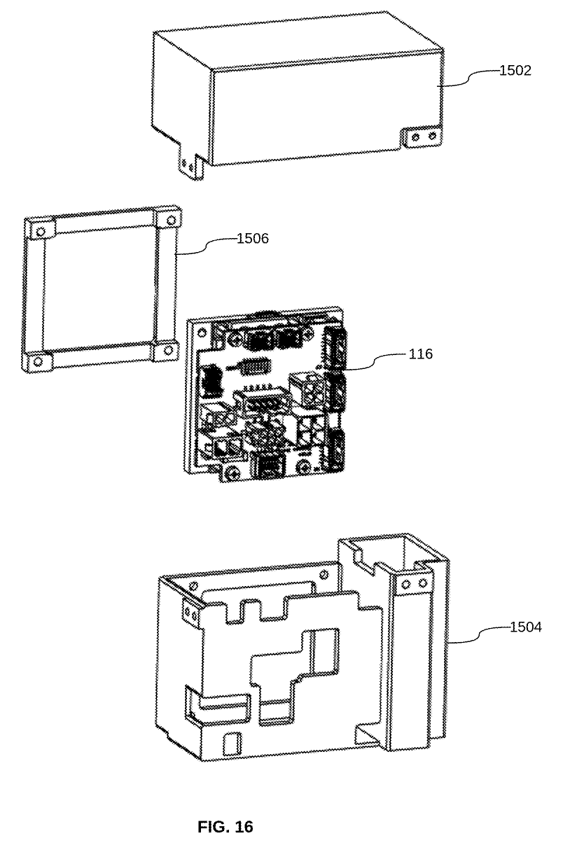

FIG. 16 illustrates but one example of an exploded view of the controller housing 1500 enclosing the electronic controller 116. As described herein with reference to FIG. 15, the controller housing 1500 includes an upper housing 1502 and a lower housing 1504 that mate together to enclose the electronic controller 116. The exploded view reveals the individual components and the spatial relationships between the components during assembly. The upper housing 1502 is configured to mate with the lower housing 1504 to define an interior cavity that receives and encloses the electronic controller 116. The electronic controller 116 comprises a printed circuit board having a plurality of electrical connectors mounted on a surface thereof. A controller mount 1506 is positioned between the upper housing 1502 and the electronic controller 116 to support the electronic controller 116 within the interior cavity. The controller mount 1506 maintains the electronic controller 116 in alignment with the openings in the lower housing 1504 such that the electrical connectors of the electronic controller 116 remain accessible through the openings. The lower housing 1504 includes mounting tabs configured to secure the controller housing 1500 to a support structure.

In some cases, the wearable haptic device is configured to be used in combination with at least one additional feedback device worn on the hand of the user. The additional feedback device may provide sensory feedback modalities that complement the force feedback provided by the wrist brace. The combination of multiple feedback modalities may enhance the realism and immersiveness of the augmented reality experience.

In some cases, the wearable haptic device includes a thermal feedback module configured to provide temperature sensations to the hand of the user in addition to force feedback. The thermal feedback module may be positioned on the hand of the user to deliver warm and cool sensations. The thermal feedback module may enable the user to perceive temperature properties of virtual objects in the augmented reality environment. For example, the user may touch a virtual object and perceive whether the virtual object has a warm or cool temperature.

In some cases, the wearable haptic device includes a vibrotactile feedback module configured to provide vibration sensations to the hand of the user. The vibrotactile feedback module may be positioned on a fingertip of the user. The vibrotactile feedback module may provide tactile cues through vibration patterns. The vibrotactile feedback module may complement the kinesthetic force feedback provided by the wrist brace by stimulating cutaneous sensory receptors in the skin.

In some cases, the electronic controller applies force compensation based on a grip method used by the user to interact with the virtual object. The grip method may comprise a pinch grip, a power grip, or a holding grip. The pinch grip involves a thumb and an index finger of the user engaging the virtual object. The power grip involves all five fingers of the user engaging the virtual object. The holding grip involves the virtual object being placed on the palm of the user without finger engagement.

In some cases, the electronic controller increases the force associated with a virtual object by a percentage based on the grip method used. The force compensation accounts for the absence of cutaneous feedback at the fingertips when interacting with virtual objects. When the user grasps a physical object, cutaneous sensory receptors in the fingertips provide tactile feedback that contributes to weight perception. In some instances, when the user grasps a virtual object, the cutaneous feedback at the fingertips is absent. The force compensation increases the force applied to the force application interface to achieve perceptual parity between virtual and physical objects of equivalent mass.

In some cases, human hands perceive force through two major sensory systems: the cutaneous system and the kinesthetic system. The cutaneous system includes mechanoreceptors in the fingertips and palm that provide information about temperature, texture, stiffness, and weight of an object. The kinesthetic system senses force feedback through muscles, tendons, and joints. The force compensation described herein increases the kinesthetic feedback applied to the hand by the device to account for the missing cutaneous feedback from the fingers. When cutaneous feedback from the fingers is not involved in an object interaction, such as in a palm holding grip where neither real nor virtual objects engage the fingers, parity in weight perception between real and virtual objects is achieved without compensation.

In some cases, the force compensation ratio increases with the mass of the virtual object for pinch and power grip methods. As the mass of the virtual object increases, the force compensation ratio increases to account for the greater contribution of kinesthetic feedback from the fingers to weight perception at higher masses. The pinch grip and the power grip both engage the fingers of the user, resulting in shear force and pressure at the fingertips when handling physical objects. The force compensation ratio for the pinch grip and the power grip may be similar for a given mass. As a user holds heavier and heavier objects, the feedback sent to the user’s brain is increasingly dominated by the strain, tension, or both in the finger joints instead of only the sensations coming from the skin of the fingers. This can become a more noticeable difference when it is missing during a virtual object interaction, hence the application of more force to account for the missing sensation in the finger joints.

In some cases, the force compensation ratio remains near unity for the holding grip method regardless of object mass. The holding grip does not engage the fingers of the user for either physical or virtual objects. Since the holding grip does not involve cutaneous feedback at the fingertips for physical objects, the force compensation for virtual objects may be minimal. The force applied to the force application interface may correspond directly to the weight assigned to the virtual object without additional compensation.

In some cases, the wrist brace has a mass of approximately 220 grams. In some cases, a remote actuation unit comprising the actuator has a mass of approximately 2000 grams. The remote positioning of the actuator on the hip belt distributes the mass of the remote actuation unit away from the hand and forearm of the user.

In some cases, the electronic controller varies the force over time to simulate at least one of inertia, buoyancy, stiffness, or damping of the virtual object. The electronic controller may implement impedance control to simulate mass, stiffness, and damping properties of virtual objects during manipulation. Impedance control enables the electronic controller to generate force responses that vary based on the position and velocity of the hand of the user.

In some cases, the electronic controller simulates inertia by varying the force applied to the force application interface based on acceleration of the hand of the user. When the user moves a virtual object, the electronic controller may apply force that resists changes in velocity to simulate the inertial mass of the virtual object. The user may perceive the sensation of moving a heavy object when shaking or accelerating the hand.

In some cases, the electronic controller simulates buoyancy by applying upward force when a virtual object is pushed down in a virtual fluid. The electronic controller may detect downward movement of the hand of the user and apply an opposing upward force to simulate the buoyant force experienced when submerging an object in a fluid. In some cases, the magnitude of the buoyant force is based on the volume of the virtual object displaced in the virtual fluid and the density of the virtual fluid. The buoyant force may increase as the virtual object is submerged deeper into the virtual fluid, corresponding to a greater displaced volume.

In some cases, the electronic controller simulates the sensation of touching a wall or surface by applying resistive force when the hand contacts a virtual surface. The electronic controller may detect contact between the hand of the user and a virtual surface in the augmented reality environment. In response to detecting the contact, the electronic controller may cause the actuator to apply a resistive force that opposes further movement of the hand into the virtual surface.

In some cases, the electronic controller simulates friction or damping by applying resistive force proportional to the velocity of hand movement. The electronic controller may receive position data from the encoder and calculate the velocity of the hand of the user. The electronic controller may apply a force that opposes the direction of movement and increases in magnitude as the velocity of the hand increases. The velocity-dependent resistive force simulates the sensation of moving an object through a viscous medium or against a frictional surface.

In some cases, the electronic controller simulates stiffness by applying force proportional to displacement of the hand from a reference position. The electronic controller may detect displacement of the hand of the user from a neutral position and apply a restoring force that increases with the magnitude of the displacement. The displacement-dependent force simulates the sensation of compressing or stretching a spring-like virtual object.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a,” “has …a,” “includes …a,” or “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A wearable device for providing haptic feedback in an augmented reality environment, the wearable device comprising:
a wrist brace configured to be worn on a forearm and a hand of a user, the wrist brace comprising a force application interface positioned on a dorsal surface of the hand, the wrist brace configured to leave fingers and a palm region of the hand substantially unobstructed; and
an actuator coupled to the wrist brace and configured to apply a force to the force application interface,
wherein the actuator is coupled to a controller configured to receive input from a head-mounted display indicating an interaction between the hand and a virtual object and, in response to the input, cause the actuator to apply the force to the force application interface.

2. The wearable device of claim 1, wherein the force is directed to cause extension or flexion of a wrist joint of the user.

3. The wearable device of claim 1, wherein the force is directed to cause adduction and abduction of a wrist joint of the user.

4. The wearable device of claim 1, wherein the actuator comprises a motor.

5. The wearable device of claim 1, wherein the actuator comprises a hydraulic actuator.

6. The wearable device of claim 1, wherein the actuator comprises a pneumatic actuator.

7. The wearable device of claim 1, wherein the actuator is located remotely from the wrist brace on the user's body, and wherein a flexible transmission couples the actuator to the wrist brace to transmit the force to the force application interface.

8. The wearable device of claim 7, wherein the flexible transmission comprises a Bowden cable and a Bowden cable sheath.

9. The wearable device of claim 7, wherein the actuator is mounted on a hip belt worn by the user.

10. The wearable device of claim 1, wherein the wrist brace further comprises an actuated joint configured to permit movement of the force application interface in wrist flexion and extension directions.

11. The wearable device of claim 1, wherein the wrist brace further comprises a passive joint configured to permit movement of the force application interface in wrist adduction and abduction directions.

12. The wearable device of claim 1, wherein the wrist brace comprises an adjustable clamp mechanism configured to accommodate different hand and wrist sizes.

13. The wearable device of claim 1, wherein the wrist brace further comprises at least one force sensor positioned in series with the actuator to measure force applied to the force application interface.

14. A method of providing haptic feedback to a user in an augmented reality environment, the method comprising:
detecting, via a head-mounted display, an interaction between a hand of the user and a virtual object in the augmented reality environment;
in response to detecting the interaction, applying a force, via an actuator, to a force application interface positioned on a dorsal surface of the hand, the force application interface configured to leave the fingers and a palm region of the user's hand substantially unobstructed; and
when the interaction with the virtual object ceases, reducing the force applied by the actuator to substantially zero to permit unimpeded interaction with physical objects.

15. The method of claim 14, wherein the force application interface is part of a wrist brace.

16. The method of claim 14, wherein the force is transmitted from the actuator to the force application interface via a flexible transmission, and wherein the actuator is located remotely from the force application interface on the user's body.

17. The method of claim 14, wherein detecting the interaction comprises detecting a gesture when a portion of the hand overlaps with the virtual object.

18. The method of claim 13, wherein detecting the interaction comprises detecting that the hand of the user comes in contact with the virtual object, and wherein the force applied to the force application interface comprises a resistive force that opposes movement of the hand into the virtual object.

19. The method of claim 14, wherein the force corresponds to a weight assigned to the virtual object.

20. The method of claim 14, further comprising applying force compensation based on a grip method used by the user to interact with the virtual object.

21. The method of claim 14, further comprising varying the force over time to simulate at least one of inertia, buoyancy, stiffness, or damping of the virtual object.

22. A system comprising:
a head-mounted display configured to render virtual objects in an augmented reality environment and to track a hand of a user;
a wearable haptic device comprising a wrist brace configured to be worn on a forearm and the hand of the user, the wrist brace comprising a force application interface positioned on a dorsal surface of the hand, the wrist brace configured to leave fingers and a palm region of the hand substantially unobstructed to preserve tracking of the hand by the head-mounted display;
an actuator coupled to the wrist brace and configured to apply a force to the force application interface; and
a processor executing code to: receive hand tracking data from the head-mounted display, determine when the hand of the user interacts with a virtual object, and command the actuator to apply the force to the force application interface to simulate a physical property of the virtual object.

23. The system of claim 22, wherein the processor executes code to operate in a transparent mode in which force applied to the hand by the actuator is minimized to permit unimpeded interaction with physical objects, and a grasp mode in which the actuator applies a force corresponding to a physical property of the virtual object.

24. The system of claim 22, wherein the wearable haptic device is configured to be used in combination with at least one additional feedback device worn on the hand of the user.
